(19) United States
(12) Patent Application Publication
(10) Pub. No.: US 2010/0203372 A1
(43) Pub. Date: Aug. 12, 2010

(54) WIRE TYPE BATTERIES FOR WIRELESS CHARGE

(75) Inventors: Ki-Won Kim, Gyeongsangnam-Do (KR); Hwi-Beom Shin, Gyeongsangnam-Do (KR); Cheol-Jin Kim, Gyeongsangnam-Do (KR); Tae-Hyun Nam, Gyeongsangnam-Do (KR); Hyo-Jun Ahn, Gyeongsangnam-Do (KR); Kwon-Koo Cho, Gyeongsangnam-Do (KR); Jou-Hyeon Ahn, Gyeongsangnam-Do (KR); Gyu-Bong Cho, Gyeongsangnam-Do (KR)

Correspondence Address: OHLANDT, GREELEY, RUGGIERO & PERLE, LLP, ONE LANDMARK SQUARE, 10TH FLOOR, STAMFORD, CT, 06901, US

(73) Assignee: Industry-Academic Cooperation Foundation Gyeonsan National University

(21) Appl. No.: 12/669,735

(22) PCT Filed: Apr. 1, 2008
(86) PCT No.: PCT/KR2008/001830

§ 371 Date: Jan. 19, 2010

(30) Foreign Application Priority Data
Jul. 20, 2007 (JP) 10-2007-0073019

(51) Int. Cl. H01M 6/10

(52) U.S. Cl. 429/94

(57) ABSTRACT

The present invention relates to the wire type battery for wireless charging which is constructed by adding the coil for wireless charging to the wire type battery, by which the present invention can provide the wire type battery for wireless charging to easily carry out charging compared to the existing wire charging method and can solve the problem in the charging which is expected from the shape of the battery to improve the effect of charging.

### TECHNICAL FIELD

The present invention relates to wire type battery applying with wireless charging method, more specifically, to wire type battery capable of wireless charging with inserting coils therein.

### BACKGROUND ART

A portable electronic device has been miniaturized as well as made progress in the multi-functional type owing to the development of nano-technologies and MEMS (Micro Electro Mechanical Systems). Hereupon, wire type battery rise into notice as a main or assistance power supply since it can make possible to effectively use of storing space in electronic device and also be surely responded to the change of electronic device through its small size. Especially, small size of wire type battery which can be produced in the wearable type, is promising to play an important role in the future as a power system capable of using in wearing computers.

Wire type battery is a kind of battery having higher length ratio to the diameter, which can be discriminated from commercial battery with its type (for example, a square type, a coin type or a cylindrical type), a size and an outward appearance, as well as sectional shape of constitutional components (for example, electrode, electrolyte and current collector)(FIGS. 1a and 1b).

These wire type batteries has difficulty in the smooth flow of electrons compared to the existing commercial battery since it constituted with electrode and current collector having much higher surface area than volume of battery.

In the battery having the ratio of cross section to length, when the existing wire charging method is just applied, it can be charged limited to the contact area of outside wire and current collector (or electrode) owing to the above phenomenon rather than charging over the whole of electrode in the battery.

In addition, the charging effect can be much lowered as the effect of resistance is relatively high in the high speed charging with high current density.

On the other hand, method for wireless charging such as method using microwave system and method inducing electromagnetic is recently introduced corresponding to the wire charging method which has been used hereto in the charging of battery.

The method using microwave is a method in that microwave power transmitting by an aerial wire is received by an antenna and is changed to a direct current through a rectifying circuit consisting of diode and filter to charge the battery. The method inducing electromagnetic is a method using the theory that a magnetic field is produced as a current flowing and again a current is produced by the magnetic field. When a power of a pad is turn on, a magnetic field is produced in the first coil in the pad and it produces a induced current in the second coil which is located in the power receiving part of electronic devices such as a mobile phone and then the inside of outside battery of electronic devices is charged with the current.

Such a wireless charging method can make possible to charge the battery even the battery has infinite length by inserting the medium (coil) capable of inducing a resonance and electromagnetism into the inside of the battery and it has also the advantage of inducing electricity from the relatively low outside magnetic field to the inside of the battery especially in the method of inducing electromagnetism because it has a reduced volume comparing to the commercial battery.

The wire type battery also has advantages to conclusively use two or more of the wire type battery and thus it can be charged conveniently and easily by introducing the wireless charging method comparing to the wire charging method which charge each battery individually. Up to now, there is no wire type battery preparing by applying the wireless charging method as well as examples practically using the same.

The inventors come to the present invention in the result of assiduously study in order to maximize the advantages of the wire type battery which can correspond to the change of electronic devices by using a storing space in electronic device and reducing a volume of the battery itself as well as to surmount the problems of the wire type battery occurred in the wire charging.

Accordingly, the purpose of the present invention is to provide wire type battery constructed with wireless charging form.

### DISCLOSURE OF INVENTION

### Technical Problem

Accordingly, the purpose of the present invention can be attained by reducing the volume compared to the existing commercial battery in such a way to insert a medium (coil) into the wire type battery making possible wireless charging as well as by inducing current from relatively low outside magnetic field into inside of the battery.

### Technical Solution

The present invention provides a wire type battery for wireless charging having single wick comprising an inside current collector, a negative or a positive inside electrode, an electrolyte, a positive or a negative outside electrode, an outside current collector and a coating material, wherein the said components are successively coated centering around the inside current collector and the coil for wireless charging is further wound between the outside current collector and the coating material.

The present invention also provides a wire type battery for wireless charging having multiple wicks wherein a number of negative and positive electrodes which is constructed with individually coated on the wire type current collector, are inserted in the electrolyte and the coil for wireless charging is coated onto outside of the electrolyte.

The present invention also provides the wire type battery for wireless charging having multiple wicks wherein the coil for wireless charging is inserted into outside of the electrolyte.

The present invention also provides a wire type battery for wireless charging wherein the inside current collector, the negative electrode, the electrolyte, the positive electrode, the outside current collector and coil for wireless charging are successively laminated and the outside of the battery is coated with the coating material.

### Advantageous Effects

The wire type battery for wireless charging of the present invention can be easily charged by using the wireless charging method compared to the existing wire charging method, and can be solved localized charging problems causing by the shape of wire type battery by inserting the inductive coil therein. The wire type battery of the present invention has high potential to use as power source in the future electronics industry such as small electronics and the wearing computer etc. an thus the present invention is very useful in the battery industry.

### BRIEF DESCRIPTION OF THE DRAWINGS

FIG. 1 is showing the wire type batteries for wireless charge of the present invention, in which a) and b) shows a circular type and a square type respectively based on the shape of cross section of battery.

FIG. 2a is showing a construction of the wire type battery having single wick as the wire type batteries for wireless charge of the present invention.

FIG. 2b is showing a construction of the wire type battery having multiple wicks as the wire type batteries for wireless charge of the present invention.

FIG. 3 is showing a construction of the wire type battery having square type cross section in accordance with the present invention.

### BEST MODE FOR CARRYING OUT THE INVENTION

In the followings, detailed structure of the wire type battery for wireless charging of the present invention will be described more detailed with reference to the attached drawings.

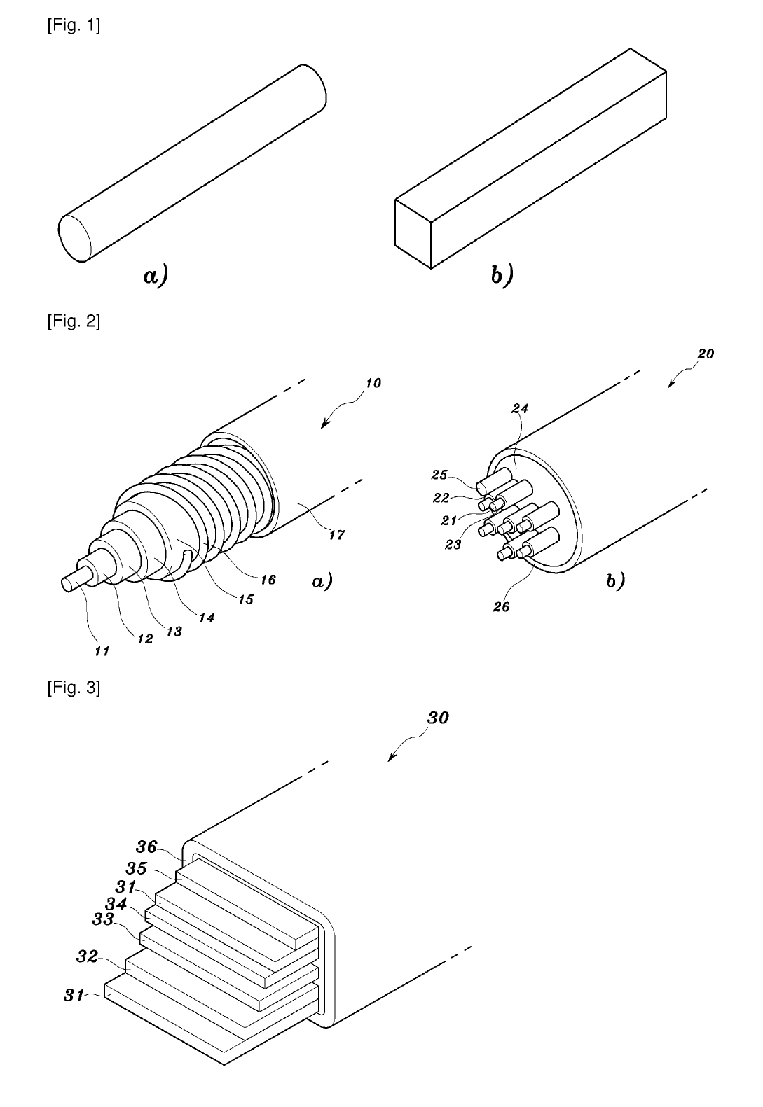

The wire type battery for wireless charging of the present invention can be formed of a circular cross section (FIG. 1a) and a square cross section (FIG. 1b) base on the shape of cross section.

The battery having circular cross section can be divided into a single wick type (FIG. 2a) and a multiple wick type (FIG. 2b).

As shown in FIG. 2a, the single wick type wire battery (10) can be constructed by successively covering or coating a negative or positive inside electrode (12), an electrolyte (13), a positive or negative inside electrode (14) and an outside current collector (15) centering around an inside current collector (11).

The single wick type wire battery (10), in order to make possible wireless charging, can be wound with a coil (16) which has a function to produce a power in each circumstance by inducing a resonance of the magnetic field and microwave being applied from the outside prior to coating a coating material (17) onto the outermost.

In such a construction, the battery can be constructed with changing a position of the positive electrode and the negative electrode in consideration of the use or the property of the battery.

As for the inside or the outside electrode (the negative or the positive electrode), it can be used an electrode made by bonding a powdered active material onto the current collector with binder or an electrode of a thin-film prepared by the chemicophysical process for the production of thin-film

The coil can be preferably prepared with a material having high electric conductivity, more preferably, a material selected from the group consisting of Cu, Al, Ti, Au, Pt, Ag or alloy thereof, or a superconductor material such as MgB₂, REBa₂Cu₃O_{7-δ}(in which, RE is rare earth element such as Y, Nd, Gd or SM). The shape of coil which is inserted into the outside of the battery can be one of a simple wire type, a solenoid type or a plate type.

As shown in FIG. 2b, the multiple wick type wire battery (20) can be constructed by inserting into the electrolyte (24) of the inside of the battery with two or more individual electrode which is prepared in the shape of wire by covering or coating the negative electrode (22) and the positive electrode (24) onto the wire current collector (21).

The individual electrode can be prepared by forming the negative electrode (22) and the positive electrode (24) over the current collector (21) with the above production method of electrode and is individually inserted in the form of wick into the inside of the electrolyte (23) base.

Then, the coil (25) which is further added for wireless charging, as shown in figures, is inserted in the outside of the electrolyte (23) base.

In FIG. 3, there is one embodiment of the wire type battery for wireless charging (30) having a square cross section of the present invention, in which the current collector (31), the negative electrode (32), the electrolyte (33), the positive electrolyte (34), the current collector (31) and the coil for wireless charging (35) are successively coated in the inside of the battery and the coating material (36) is coated over the outside. The arrangement of the positive electrode and the negative electrode can also be changed according to the property of the battery.

The electrode can be prepared with the same method as described above, but also prepared by using a plate type of support for supporting the electrode. In case of the battery having a square cross section, it is preferred to insert the coil into the upper part or lower part of the electrode, or to wrap the outermost of the electrode with the coil.

The shape of the battery proposed above is related to a unit wire type battery, but two or more units can be combined to use based on the use.

When the wire type battery of the present invention is positioned with straightly or spirally over a pad having mobile magnetic field, an induced electricity voltage is occurred on the coil for charging of the battery. When the electricity is connected to the negative electrode and the positive electrode via a charging circuit of a diode rectifier, the battery is charged with the electricity. Accordingly, the wire type battery of the present invention is fully charged with positioning the battery over a pad having mobile magnetic field within a regular period.

What is claimed is:

1. A wire type battery for wireless charging having single wick comprising an inside current collector, a negative or a positive inside electrode, an electrolyte, a positive or a negative outside electrode, an outside current collector and a coating material, wherein the said components are successively coated centering around the inside current collector and the coil for wireless charging is further wound between the outside current collector and the coating material.

2. A wire type battery for wireless charging having multiple wicks comprising a inside current collector, a positive inside electrode, an electrolyte, a negative electrode, an outside current collector and a coating material, wherein a number of negative and positive electrodes which is constructed with individually coated on the wire type current collector, are inserted in the electrolyte and the coil for wireless charging is coated onto outside of the electrolyte.

3. The wire type battery for wireless charging according to claim 2, wherein the coil for wireless charging is inserted into outside of the electrolyte.

4. A wire type battery for wireless charging wherein the inside current collector, the negative electrode, the electrolyte, the positive electrode, the outside current collector and the coil for wireless charging are successively laminated and the outside of the battery is coated with the coating material.

5. The wire type battery for wireless charging according to claim 1, wherein the coil is prepared with a material selected from the group consisting of Cu, Al, Ti, Au, Pt, Ag or alloy thereof, or MgB, REBa Cu O (in which, RE is rare earth element such as Y, Nd, Gd or SM).

6. The wire type battery for wireless charging according to claim 2, wherein the coil is prepared with a material selected from the group consisting of Cu, Al, Ti, Au, Pt, Ag or alloy thereof, or MgB , REBa Cu O (in which, RE is rare earth element such as Y, Nd, Gd or SM).

7. The wire type battery for wireless charging according to claim 4, wherein the coil is prepared with a material selected from the group consisting of Cu, Al, Ti, Au, Pt, Ag or alloy thereof, or MgB , REBa Cu O (in which, RE is rare earth element such as Y, Nd, Gd or SM).
